(19) United States
(12) Patent Application Publication
(10) Pub. No.: US 2026/0050277 A1
(43) Pub. Date: Feb. 19, 2026

(54) VOLTAGE REGULATOR CIRCUIT, LOW DROPOUT REGULATOR CHIP, CHIP SYSTEM, AND ELECTRONIC DEVICE

(71) Applicant: HUAWEI TECHNOLOGIES CO., LTD., Shenzhen (CN)

(72) Inventors: Maodong WANG, Shanghai (CN); Fei GUO, Shanghai (CN)

(73) Assignee: HUAWEI TECHNOLOGIES CO., LTD., Shenzhen (CN)

(21) Appl. No.: 19/367,354

(22) Filed: Oct. 23, 2025

Related U.S. Application Data
(63) Continuation of application No. PCT/CN2024/088570, filed on Apr. 18, 2024.

(30) Foreign Application Priority Data
Apr. 25, 2023 (CN) 202310476998.1

(51) Int. Cl. G05F 1/56; G05F 1/46; G05F 1/59; G05F 3/26

(52) U.S. Cl. CPC G05F 1/561; G05F 1/465; G05F 1/59; G05F 3/26

(57) ABSTRACT

The present disclosure relates to voltage regulator circuits, low dropout regulator chips, chip systems, and electronic devices. An example voltage regulator circuit includes a voltage input end, a voltage output end, a first voltage end, a second voltage end, an LDO, a first comparator, a first delay circuit, and a plurality of first switch circuits. The LDO is configured to receive a reference voltage at the voltage input end, and output a first voltage. The voltage output end is configured to receive the first voltage, and output a second voltage. The first comparator is configured to receive a first threshold voltage at the first voltage end and the second voltage, and output a first comparison result.

### CROSS-REFERENCE TO RELATED APPLICATIONS

This application is a continuation of International Application No. PCT/CN2024/088570, filed on Apr. 18, 2024, which claims priority to Chinese Patent Application No. 202310476998.1, filed on Apr. 25, 2023. The disclosures of the aforementioned applications are hereby incorporated by reference in their entireties.

### TECHNICAL FIELD

This application relates to the field of electronic technologies, and in particular, to a voltage regulator circuit, a low dropout regulator chip, a chip system, and an electronic device.

### BACKGROUND

As one of core modules of a power management system, a low dropout regulator (LDO) is widely used in a new type of memory and a high-speed digital circuit because of advantages such as a simple circuit structure, a small size, low noise, and a small quantity of peripheral electronic devices. Currently, in an application process of the LDO, when an external load current of the LDO changes, large overshoot or undershoot occurs in a transient amplitude of an output voltage of the LDO, resulting in a voltage ripple (instability) in the output voltage. However, stability of the output voltage has direct impact on load performance.

### SUMMARY

Embodiments of this application provide a voltage regulator circuit, a low dropout regulator chip, a chip system, and an electronic device, to resolve a problem of unstable output voltage.

To achieve the foregoing objective, this application uses the following technical solutions.

According to a first aspect of embodiments of this application, a voltage regulator circuit is provided. The voltage regulator circuit includes a voltage input end, a voltage output end, a first voltage end, and a second voltage end, and further includes a low dropout regulator, a first comparator, a first delay circuit, and a plurality of first switch circuits. The low dropout regulator serves as a main module (or a body module) of the low dropout regulator in the voltage regulator circuit, and the first comparator, the first delay circuit, and the plurality of first switch circuits may serve as transient response enhancement modules in the voltage regulator circuit. The low dropout regulator is configured to: receive a reference voltage at the voltage input end, and output a first voltage. The voltage output end is configured to: receive the first voltage, and output a second voltage. The first comparator is configured to: receive a first threshold voltage at the first voltage end and the second voltage, and output a first comparison result. The first delay circuit is configured to: receive the first comparison result, and output a plurality of first control signals. The plurality of first switch circuits are disposed in parallel, and each first switch circuit is configured to: receive the first control signal, and regulate connection and disconnection between the second voltage end and the voltage output end.

In embodiments of this application, for a structure of the voltage regulator circuit that uses a digital-analog hybrid architecture, the first comparator is disposed in the voltage regulator circuit, to quickly respond to a change of the second voltage output at the voltage output end. In addition, the first delay circuit is configured to control the plurality of first switch circuits to be turned on stage by stage, so that a compensation path between the second voltage end and the voltage output end is established, to compensate for a significant change of the second voltage (an output voltage of the voltage regulator circuit) caused by an instantaneous change of a load current, thereby remaining the second voltage within a threshold range and improving stability of the output voltage of the voltage regulator circuit. Furthermore, because a value of a current injected (or discharged) to the voltage output end may be adjusted by using the plurality of first switch circuits, a value of a current injected (or discharged) to the voltage input end through the second voltage end may be determined based on an actual application scenario, and a load current change range that can be coped with is large. Moreover, when the plurality of first switch circuits are turned on at different stages, in an application scenario in which the load current changes slightly, the second voltage can be compensated to be within the threshold range when some first switch circuits are turned on. In this case, the remaining first switch circuits do not need to be turned on. This helps reduce dynamic power consumption. Additionally, a circuit structure included in the voltage regulator circuit may be an on-chip integrated structure, so that an area of the voltage regulator circuit can be reduced, and additional costs caused by introducing an off-chip capacitor can be eliminated. In addition, when the second voltage end is a supply voltage end, because a charging path in which the first switch circuit is located draws a large current from the second voltage end, and there is a parasitic inductor on a pad bonding (bonding) wire of the second voltage end, drawing a current from the second voltage end causes noise fluctuation generated by a supply voltage at the second voltage end, to affect normal operation of another module. However, in embodiments of this application, the plurality of first switch circuits are turned on stage by stage, so that a quantity of drawing times is increased based on multi-stage control logic, to reduce the current drawn from the second voltage end each time. A smaller current drawn each time indicates a smaller amplitude of noise fluctuation generated by the supply voltage. Therefore, a problem that the supply voltage fluctuates greatly can be resolved.

In a possible implementation, the voltage regulator circuit further includes a first current source circuit. The first current source circuit is coupled between the second voltage end and the plurality of first switch circuits.

The first current source circuit is disposed between the second voltage end and the first switch circuit, so that the first current source circuit can provide an accurate and fixed charging current value, to improve accuracy of compensating for the second voltage, and resolve a problem of a charging/discharging current change value in a wide supply voltage range.

In a possible implementation, the voltage regulator circuit further includes a first reverse coupling circuit. The first reverse coupling circuit is coupled between the first delay circuit and the first current source circuit.

The first reverse coupling circuit is disposed, so that a static operating point of the first current source circuit can be stabilized, charging/discharging current fluctuation of the first current source circuit can be compensated for, and impact of coupling noise on accuracy of the charging current value can be reduced. In this way, the current of the first current source circuit can be more accurately replicated to the voltage output end, and stability of the charging current value is maintained. In addition, noise impact on the supply voltage can be reduced.

In a possible implementation, the first delay circuit includes a plurality of first delay modules connected in series, a first comparison result input end, and a plurality of first control signal output ends. Each of an input end and an output end of each first delay module is provided with a first control signal output end. The first delay circuit is configured to: receive the first comparison result through the first comparison result input end, and output the first control signal through the first control signal output end.

In embodiments of this application, the first delay circuit includes the plurality of first delay modules, the plurality of first delay modules are configured to control the plurality of first switch circuits to be sequentially turned on, and paths on which the plurality of first switch circuits are located obtain currents from the second voltage end at different times, so that voltage fluctuation of the second voltage end can be effectively reduced. In addition, in the application scenario in which the load current changes slightly, turning on the first switch circuits at different stages helps reduce dynamic power consumption.

In a possible implementation, the first delay circuit further includes a plurality of OR gates. The OR gate is configured to: receive signals from the input end and the output end of the first delay module, and output a signal obtained through an OR operation to the first control signal output end.

By disposing the OR gate in the first delay circuit, after the second voltage output at the voltage output end is regulated to a normal range, the first comparison result output by the first comparator is used to control all the first switch circuits to be directly turned off. This can mitigate a case of overcompensation of the second voltage caused by delayed turn-off of a next-stage first switch circuit.

In a possible implementation, the first delay circuit further includes a plurality of AND gates. The AND gate is configured to: receive signals from the input end and the output end of the first delay module, and output a signal obtained through an AND operation to the first control signal output end.

By disposing the AND gate in the first delay circuit, after the second voltage output at the voltage output end is regulated to a normal range, the first comparison result output by the first comparator is used to control all the first switch circuits to be directly turned off. This can mitigate a case of overcompensation of the second voltage caused by delayed turn-off of a next-stage first switch circuit.

In a possible implementation, the first comparator includes a plurality of stages of cascaded first operational amplifiers.

The plurality of stages of first operational amplifiers are disposed in the first comparator, so that a gain of the first comparator can be greatly increased.

In a possible implementation, the first comparator further includes a plurality of stages of first inverters coupled to output ends of the plurality of stages of first operational amplifiers.

The plurality of stages of first inverters are disposed in the first comparator, so that a capability of driving the first switch circuit can be improved, to expand a change range (swing) of the voltage output at the voltage output end, and implement a high-gain and high-speed first comparator. The high-gain and high-speed first comparator can improve a processing speed of the first comparator, to improve a response speed of a charging module, shorten a recovery time of the second voltage output at the voltage output end, and improve a transient response characteristic of the voltage regulator circuit.

In a possible implementation, the first switch circuit includes a first transistor. A control electrode of the first transistor is coupled to the first delay circuit, a first electrode of the first transistor is coupled to the second voltage end, and a second electrode of the first transistor is coupled to the voltage output end. This is a first switch circuit with a simple structure.

In a possible implementation, the first transistor is a P-type transistor, and the second voltage end is the supply voltage end. In this way, the voltage regulator circuit can adjust undershoot of the voltage output at the voltage output end.

In a possible implementation, the first transistor is an N-type transistor, and the second voltage end is a reference ground voltage end. In this way, the voltage regulator circuit can adjust overshoot of the voltage output at the voltage output end.

In a possible implementation, the first current source circuit includes a current mirror.

The current mirror serves as a current source, so that a charging current value is stable, and the current mirror is applicable to a medium-to-high frequency (hundreds of megahertz level) chip (for example, an MCU chip) with a wide supply voltage range.

In a possible implementation, the first current source circuit includes a second transistor, a first current source, and a plurality of third transistors. A control electrode of the second transistor is coupled to control electrodes of the plurality of third transistors and a second electrode of the second transistor, a first electrode of the second transistor is coupled to the second voltage end, and the second electrode of the second transistor is coupled to the first current source; the first current source is further coupled to a third voltage end; and a first electrode of each third transistor is coupled to the second voltage end, and a second electrode of each third transistor is coupled to one of the first switch circuits. This is a current mirror structure with a simple structure.

In a possible implementation, the second voltage end and the third voltage end serve as the supply voltage end and the reference ground voltage end for each other. In this way, the voltage regulator circuit can adjust overshoot or undershoot of the voltage output at the voltage output end.

In a possible implementation, the first reverse coupling circuit includes a second inverter and a first capacitor; and the second inverter and the first capacitor are coupled in series between the first control signal output end and the control electrode of the third transistor. This is a first reverse coupling circuit with a simple structure.

In a possible implementation, the voltage regulator circuit further includes a second comparator, a second delay circuit, a plurality of second switch circuits connected in parallel, a fourth voltage end, and a fifth voltage end. The second comparator is configured to: receive a second threshold voltage at the fourth voltage end and the second voltage, and output a second comparison result. The second delay circuit is configured to: receive the second comparison result, and output a plurality of second control signals. Each second switch circuit is configured to: receive the second control signal, and regulate connection and disconnection between the fifth voltage end and the voltage output end. In this way, the voltage regulator circuit may have a capability of adjusting the overshoot and undershoot that occur in the voltage output at the voltage output end.

In a possible implementation, the voltage regulator circuit further includes a second current source circuit; and the second current source circuit is coupled between the fifth voltage end and the plurality of second switch circuits.

The second current source circuit is disposed between the fifth voltage end and the second switch circuit, so that the second current source circuit can provide an accurate and fixed charging current value, to improve accuracy of compensating for the second voltage, and resolve a problem of a charging/discharging current change value in a wide supply voltage range.

In a possible implementation, the voltage regulator circuit further includes a second reverse coupling circuit; and the second reverse coupling circuit is coupled between the second delay circuit and the second current source circuit.

The second reverse coupling circuit is disposed, so that a static operating point of the second current source circuit can be stabilized, charging/discharging current fluctuation of the second current source circuit can be compensated for, and impact of coupling noise on accuracy of the charging current value can be reduced. In this way, the current of the second current source circuit can be more accurately replicated to the voltage output end, and stability of the charging current value is maintained. In addition, noise impact on the supply voltage can be reduced.

According to a second aspect of embodiments of this application, a low dropout regulator chip is provided, including a substrate and the voltage regulator circuit according to any one of the first aspect and the possible implementations of the first aspect. The voltage regulator circuit is disposed on the substrate.

According to a third aspect of embodiments of this application, a chip system is provided, including the voltage regulator circuit according to any one of the first aspect and the possible implementations of the first aspect or the low dropout regulator chip according to the second aspect, and a load circuit. The voltage output end of the voltage regulator circuit is coupled to the load circuit.

According to a fourth aspect of embodiments of this application, an electronic device is provided, including the voltage regulator circuit according to any one of the first aspect and the possible implementations of the first aspect or the low dropout regulator chip according to the second aspect or the chip system according to the third aspect, and a circuit board. The voltage regulator circuit is disposed on the circuit board.

According to a fifth aspect of embodiments of this application, a voltage regulator circuit driving method is provided. The method includes: A reference voltage is input at a voltage input end; a low dropout regulator receives the reference voltage, and outputs a first voltage; the first voltage is received and a second voltage is output at a voltage output end; a first threshold voltage is input at a first voltage end; a first comparator receives the second voltage and the first threshold voltage, and outputs a first comparison result; a first delay circuit receives the first comparison result, and outputs a plurality of first control signals; and a plurality of first switch circuits separately receive the first control signals, and regulate connection and disconnection between a second voltage end and the voltage output end.

### BRIEF DESCRIPTION OF DRAWINGS

FIG. 1 is a diagram of an architecture of an MCU according to an embodiment of this application;

FIG. 2A to FIG. 2C are diagrams of topologies of a voltage regulator circuit according to an embodiment of this application;

FIG. 3 is a diagram of an architecture of a voltage regulator circuit according to an embodiment of this application;

FIG. 4 is a diagram of a topology of a voltage regulator circuit according to an embodiment of this application;

FIG. 5A and FIG. 5B are diagrams of structures of a first comparator according to an embodiment of this application;

FIG. 6A and FIG. 6B are diagrams of structures of a first delay circuit according to an embodiment of this application;

FIG. 7 is a diagram of a detailed structure of a voltage regulator circuit according to an embodiment of this application;

FIG. 8 is an effect diagram of transient response of a voltage regulator circuit to undershoot according to an embodiment of this application;

FIG. 9 is a diagram of a topology of a voltage regulator circuit according to an embodiment of this application;

FIG. 10 is a diagram of a structure of a second delay circuit according to an embodiment of this application;

FIG. 11 is a diagram of a structure of a voltage regulator circuit according to an embodiment of this application; and

FIG. 12 is a diagram of a topology of a voltage regulator circuit according to an embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

Terms such as “second” and “first” below are only for ease of description, and cannot be understood as indicating or implying relative importance or implicitly indicating a quantity of indicated technical features. Therefore, a feature limited by “second”, “first”, or the like may explicitly or implicitly include one or more features. In the descriptions of this application, unless otherwise specified, “a plurality of” means two or more.

In addition, in embodiments of this application, orientation terms such as “upper”, “lower”, “left”, and “right” may include but are not limited to definitions based on illustrated orientations in which components in the accompanying drawings are placed. It should be understood that, these directional terms may be relative concepts. They are used for description and clarification of relative positions, and may vary accordingly depending on a change in the orientations in which the components in the accompanying drawings are placed in the accompanying drawings.

In embodiments of this application, unless otherwise clearly specified and limited, the term “connection” should be understood in a broad sense. For example, the “connection” may be a fixed connection, a detachable connection, or an integral connection, may be a direct connection, or may be an indirect connection through an intermediate medium. In addition, the term “coupling” may be a direct electrical connection, or may be an indirect electrical connection through an intermediate medium. The term “contact” may be direct contact or indirect contact through an intermediate medium.

In embodiments of this application, the term “and/or” describes an association relationship between associated objects and may indicate that three relationships exist. For example, A and/or B may indicate the following cases: Only A exists, both A and B exist, and only B exists, where A and B may be singular or plural. The character “/” generally indicates an “or” relationship between the associated objects.

A transistor in embodiments of this application may be a metal oxide semiconductor (MOS) field-effect transistor (which may be referred to as a MOS transistor for short). In embodiments of this application, a control end of the transistor may be a gate of the transistor. In a possible embodiment, a first electrode of the transistor may be a source, and a second electrode may be a drain. In another possible embodiment, a first electrode of the transistor may be a drain, and a second electrode may be a source.

Embodiments of this application provide an electronic device. The electronic device is, for example, a consumer electronic product, a home electronic product, a financial terminal product, a communication electronic product, a medical instrument electronic product, or an automobile electronic product. The consumer electronic product is, for example, a mobile phone (mobile phone), a tablet computer (pad), a notebook computer, an e-reader, a personal computer (PC), a personal digital assistant (PDA), a desktop display, an intelligent wearable product (for example, a smartwatch or a smart band), a virtual reality (VR) electronic device, an augmented reality (AR) electronic device, or an uncrewed aerial vehicle. The home electronic product is, for example, a smart door lock, a television, a remote control, a refrigerator, or a small charging home appliance (for example, a soy milk maker or a robot vacuum). The financial terminal product is, for example, an automated teller machine (ATM) or a terminal for self-help service handling. The communication electronic product is, for example, a communication electronic device like a server, a nonvolatile memory, a radar, or a base station. The medical instrument electronic product is, for example, any type of detection instrument, or an oxygen making machine. A specific form of the electronic device is not specially limited in embodiments of this application.

A microcontroller (also referred to as a microcontroller unit, microcontroller unit, MCU) is a microprocessor chip designed for control processing of a specific application, where a central processing unit (CPU), a memory (including a volatile memory and a nonvolatile memory), a plurality of input/output (I/O) interfaces, and the like are integrated on one chip to form a chip-level computer. The MCU is widely applied to the fields such as industrial control, intelligent electronic devices, household appliances, medical instruments, and automotive electronics.

The electronic device provided in embodiments of this application may include, for example, an MCU, and the MCU may be disposed on a circuit board of the electronic device.

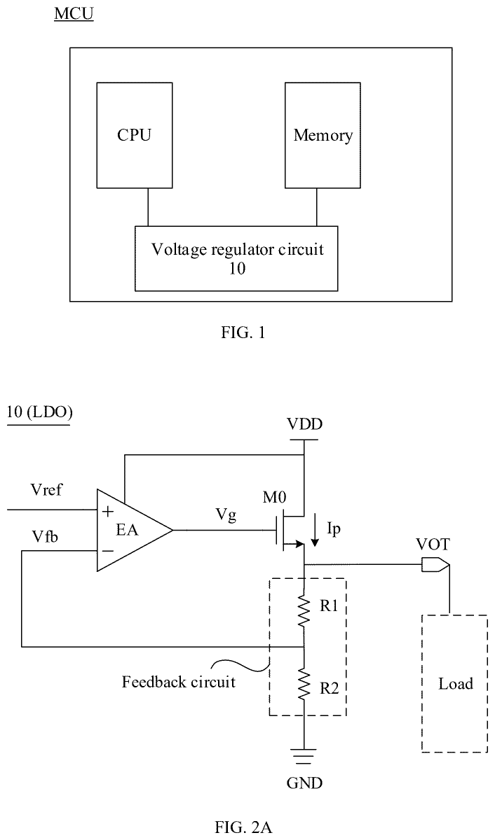

FIG. 1 is a diagram of an architecture of an MCU according to an embodiment of this application.

FIG. 1 shows an example of the MCU. The MCU includes a CPU, a memory, and a voltage regulator circuit 10. The CPU and the memory are configured to provide processing and storage functions for an electronic device, and may be integrated into the MCU. The voltage regulator circuit 10 is configured to provide the MCU with a supply voltage required for operation.

The voltage regulator circuit 10 becomes a mainstream choice for an MCU power supply module due to advantages such as a simple circuit structure, a small size, low noise, and a small quantity of peripheral electronic devices.

Generally, an operating current of the MCU can reach a maximum of dozens of milliamperes, and the operating current changes rapidly due to a change of an application scenario. This requires the voltage regulator circuit 10 to provide a stable output voltage in various application scenarios.

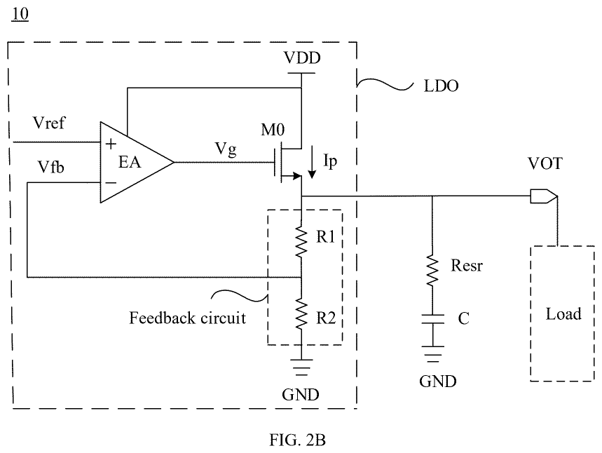

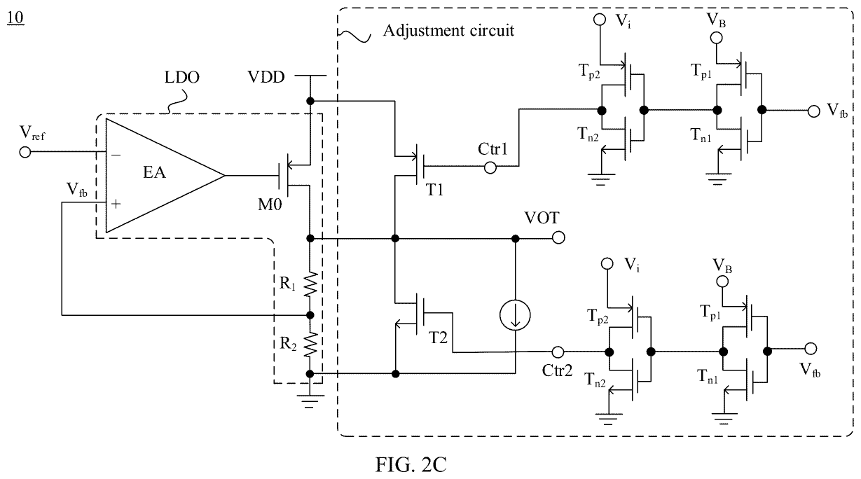

FIG. 2A to FIG. 2C are diagrams of topologies of a voltage regulator circuit according to an embodiment of this application.

For a structure of the voltage regulator circuit 10, in some embodiments, as shown in FIG. 2A, the voltage regulator circuit 10 includes a low dropout regulator (LDO).

The LDO may include an error amplifier (EA), a transistor M0, and a feedback circuit. The feedback circuit includes a first resistor R1 and a second resistor R2.

For example, the transistor M0 is a P-type metal field-effect transistor (positive channel metal oxide semiconductor, PMOS). An output end of the error amplifier EA is coupled to a control end of the transistor M0 (namely, a gate of the PMOS). A first electrode of the transistor M0 (for example, a drain of the PMOS) serves as a voltage output terminal VOT of the LDO, and is also coupled to an input end of the feedback circuit. A second electrode of the transistor M0 (for example, a source of the PMOS) is coupled to a supply voltage end VDD. An output end of the feedback circuit is coupled to a negative-phase input end of the error amplifier EA, and a positive-phase input end of the error amplifier EA is configured to receive a reference voltage Vref. The received reference voltage Vref may be generated, for example, by using a bandgap (bandgap, BG) reference circuit. The voltage output end VOT provides a next-stage load with a fixed voltage value that is independent of a supply voltage Vdd of the supply voltage end VDD.

Specifically, when the LDO is powered on or the next-stage load changes, an overshoot or undershoot phenomenon occurs in a second voltage v2 output at the voltage output end VOT of the LDO. In this case, the feedback circuit samples the second voltage v2 by using the first resistor R1 and the second resistor R2, and a feedback voltage Vfb obtained through sampling is transmitted to the negative-phase input end of the error amplifier EA. The error amplifier EA compares the feedback voltage Vfb with the reference voltage Vref received at the positive-phase input end, and amplifies the feedback voltage Vfb and the reference voltage Vref. An amplified voltage serves as a gate voltage Vg of the transistor M0. The gate voltage Vg dynamically adjusts the second voltage v2 by changing a conduction current Ip flowing through the transistor M0, to implement regulated voltage output of the LDO.

For example, when the second voltage v2 decreases, the feedback voltage Vfb decreases, and a decrease of the feedback voltage Vfb causes a decrease of the gate voltage Vg. As the gate voltage Vg decreases, the conduction current Ip increases, so that the second voltage v2 increases. Similarly, when the second voltage v2 increases, the feedback voltage Vfb increases, and an increase of the feedback voltage Vfb causes an increase of the gate voltage Vg. As the gate voltage Vg increases, the conduction current Ip decreases, so that the second voltage v2 decreases.

In some other embodiments, as shown in FIG. 2B, in addition to the LDO, the voltage regulator circuit 10 further includes an off-chip capacitor C and an equivalent parasitic resistor Resr introduced by the off-chip capacitor C. The equivalent parasitic resistor Resr introduces a zero point to the voltage regulator circuit 10, and the zero point may be used to cancel impact of a secondary pole, to meet a stability requirement.

When a load current changes abruptly, the voltage regulator circuit 10 with the off-chip capacitor mainly relies on charging and discharging of the off-chip capacitor C to maintain stability of the second voltage v2, to avoid excessive undershoot and overshoot that occur in the second voltage v2. For example, when the load changes from a light load to a heavy load, due to a bandwidth limitation, the transistor M0 cannot immediately provide a sufficient current, and the off-chip capacitor C provides a remaining current in a short time. The following formula is a definition formula of an undershoot value of the second voltage v2, where Δ I_{OUT} indicates a change value of the load current; t1 indicates an undershoot time, and a value of t1 depends on a closed-loop bandwidth and a voltage swing rate of the LDO; and Δ V_{ESR} indicates a difference between voltages at two ends of the equivalent parasitic resistor Resr. It can be learned from Formula (1) that, in a same time, a larger off-chip capacitor C indicates a smaller undershoot value of the second voltage v2.

$$Δ {V}_{OUT} = \frac{Δ {I}_{OUT}}{{C}_{out}} {t}_{1} + Δ {V}_{ESR} \qquad ( 1 )$$

For the voltage regulator circuit 10 with the off-chip capacitor, it is easier to ensure system stability by selecting an output capacitor with a large equivalent parasitic resistance Resr. Therefore, an expensive tantalum capacitor has to be selected, to increase design costs. In addition, a capacitance value of the off-chip capacitor C usually needs to be at a μF level. During design, a dedicated pin needs to be reserved to connect the off-chip capacitor C. Parasitic inductance and antenna effect on a connection line (for example, a bonding (bonding) line) between the LDO and the off-chip capacitor C may reduce quality of the second voltage v2 of the voltage regulator circuit 10.

In some other embodiments, as shown in FIG. 2C, in addition to the LDO, the voltage regulator circuit 10 further includes an on-chip integrated regulator circuit. A structure of the regulator circuit is shown in FIG. 2C.

When overshoot and undershoot occur in a voltage output at the voltage output end VOT, the feedback voltage Vfb changes accordingly. The regulator circuit senses the change of the feedback voltage Vfb, and directly compensates for the detected overshoot or undershoot by using the regulator circuit. The regulator circuit charges and discharges the voltage output at the voltage output end VOT, to reduce the overshoot and the undershoot.

The structure of the voltage regulator circuit 10 in this solution is simple, but a charging/discharging current is directly drawn by using a transistor T1 and a transistor T2, which causes large noise impact on the supply voltage. In addition, to cope with a large load current change, there is high static power consumption, a load current regulation capability is limited, and a wide supply voltage range is not applicable.

In view of this, embodiments of this application further provide a voltage regulator circuit 10, to reduce noise impact on a supply voltage while improving instability of an output voltage of the voltage regulator circuit 10.

The following uses several examples to describe the voltage regulator circuit 10 provided in embodiments of this application.

### Example 1

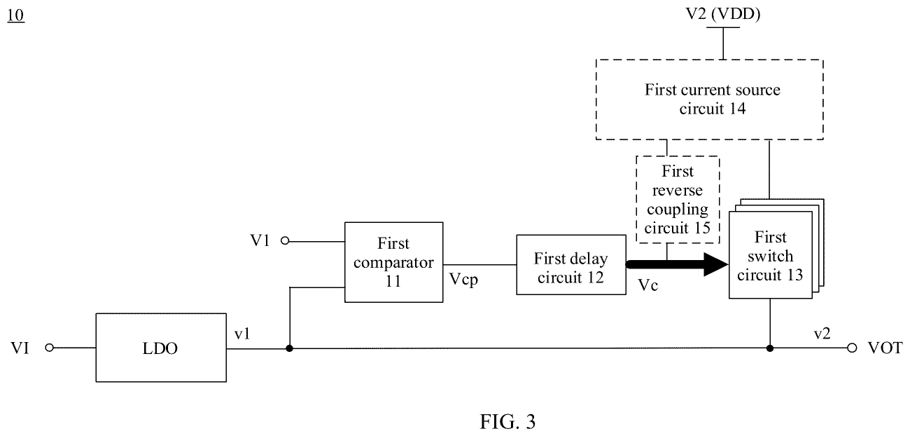

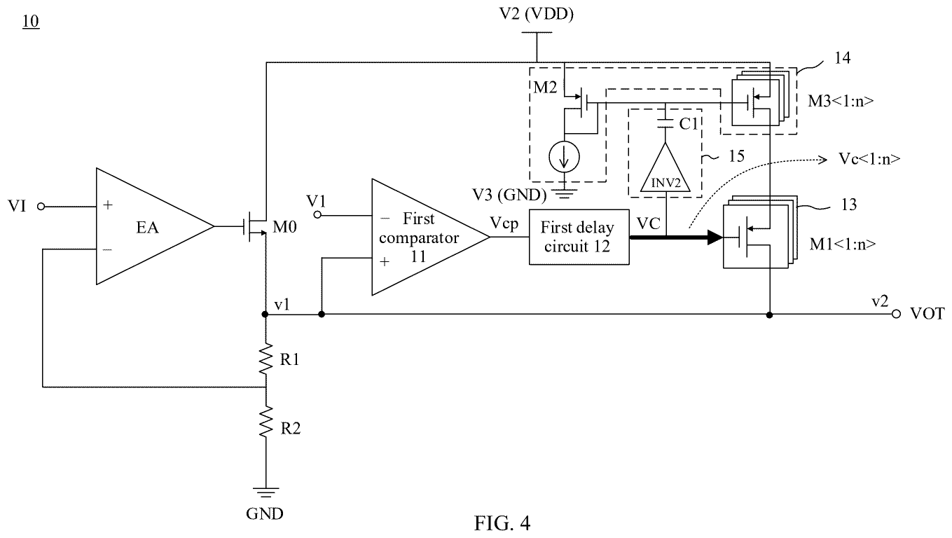

FIG. 3 is a diagram of an architecture of a voltage regulator circuit according to an embodiment of this application. FIG. 4 is a diagram of a topology of a voltage regulator circuit according to an embodiment of this application.

As shown in FIG. 3, this embodiment of this application provides a voltage regulator circuit 10. The voltage regulator circuit 10 may be integrated into a chip (a bare chip or a packaged chip).

The voltage regulator circuit 10 includes a voltage input end VI, a voltage output end VOT, a first voltage end V1, and a second voltage end V2. The voltage input end VI is, for example, configured to receive a reference voltage Vref, and the reference voltage Vref is, for example, provided by a bandgap (bandgap, BG) reference circuit. The voltage output end VOT is configured to output a stable second voltage v2 to a load. The first voltage end VI is, for example, configured to receive a first threshold voltage, and the first threshold voltage serves as a comparative voltage, to determine whether undershoot (undershoot) occurs in the voltage regulator circuit 10. The second voltage end V2 may be, for example, a supply voltage end VDD, and be configured to receive a supply voltage Vdd.

The voltage regulator circuit 10 further includes a low dropout regulator LDO and a charging module. The charging module includes a first comparator (comparator) 11, a first delay circuit 12, and a plurality of first switch circuits 13.

The low dropout regulator LDO is configured to: receive the reference voltage Vref at the voltage input end VI, and output a first voltage v1.

In some embodiments, as shown in FIG. 4, the low dropout regulator LDO includes an error amplifier EA, a transistor M0, and a feedback circuit. The feedback circuit includes a first resistor R1 and a second resistor R2.

A first input end of the error amplifier EA is coupled to the voltage input end VI, a second input end of the error amplifier EA is coupled between the first resistor R1 and the second resistor R2, and an output end of the error amplifier EA is coupled to a control electrode of the transistor M0.

A first electrode of the transistor M0 is coupled to a first end of the first resistor R1, and a second electrode of the transistor M0 is coupled to a second voltage end.

A first end of the second resistor R2 is coupled to the first end of the first resistor R1, and a second end of the second resistor R2 is coupled to a reference ground voltage end GND.

An output end of the low dropout regulator LDO is coupled between the first electrode of the transistor M0 and the first end of the first resistor R1, and the output end of the low dropout regulator LDO is configured to output the first voltage v1.

Certainly, a structure of the low dropout regulator LDO is not limited in embodiments of this application. All low dropout regulators LDOs in a related technology are applicable to embodiments of this application. The structure of the low dropout regulator LDO shown in FIG. 4 is merely an example.

The voltage output end VOT is configured to: receive the first voltage v1 output by the low dropout regulator LDO, and output the second voltage v2.

It may be understood that the second voltage v2 is equal to the first voltage v1 when the first voltage v1 is within a threshold range. When undershoot occurs in the first voltage v1, the second voltage v2 is a stable voltage obtained by compensating for the first voltage v1.

Still refer to FIG. 3. The first comparator 11 is configured to: receive the first threshold voltage Vl at the first voltage end V1 and the second voltage v2, compare the first threshold voltage Vl with the second voltage v2, and then output a first comparison result Vcp.

For example, a first input end of the first comparator 11 is coupled to the first voltage end V1, and the first input end of the first comparator 11 is configured to receive the first threshold voltage Vl. A second input end of the first comparator 11 is coupled to the output end of the low dropout regulator LDO, and the second input end of the first comparator 11 is configured to receive the second voltage v2. An output end of the first comparator 11 is coupled to the first delay circuit 12, and the output end of the first comparator 11 is configured to output the first comparison result to the first delay circuit 12.

The first comparator 11 is configured to: detect a change of the second voltage v2, and use the first threshold voltage Vl as a minimum reference voltage within an acceptable range. When the second voltage v2 is less than the first threshold voltage Vl, it is determined that undershoot occurs in the second voltage v2. The first comparison result Vcp indicates that undershoot occurs in the second voltage v2. When the second voltage v2 is greater than the first threshold voltage Vl, it is determined that no undershoot occurs in the second voltage v2. The first comparison result Vcp indicates that no undershoot occurs in the second voltage v2.

For example, the first comparator 11 is a P-type comparator. When undershoot occurs in the second voltage v2, the first comparison result Vcp is “0”. When no undershoot occurs in the second voltage v2, the first comparison result Vcp is “1”.

A type of the first comparator 11 is not limited in embodiments of this application, and a type of the first comparison result Vcp is not limited either. When undershoot occurs in the second voltage v2, the first comparison result Vcp output by the first comparator 11 may be used to control the first switch circuit 13 to be turned on. In embodiments of this application, for example, the first comparator 11 is a P-type comparator, the first comparison result Vcp is “0” when undershoot occurs in the second voltage v2, and the first comparison result Vcp is “1” when no undershoot occurs in the second voltage v2.

Certainly, a value of the first threshold voltage Vl is not limited in embodiments of this application.

A structure of the first comparator 11 is not limited in embodiments of this application, and all comparators in the related technology are applicable to embodiments of this application.

In some embodiments, the first comparator 11 is a high-speed comparator. For example, the first comparator 11 is a comparator whose output delay is at a nanosecond level.

FIG. 5A and FIG. 5B are diagrams of structures of the first comparator 11 according to an embodiment of this application.

In some embodiments, as shown in FIG. 5A, the first comparator 11 includes a plurality of stages of cascaded first operational amplifiers (operational amplifiers) OP1. In FIG. 5A, an example in which the first comparator 11 includes three stages of cascaded first operational amplifiers OP1 is used for illustration.

An input end of a first-stage first operational amplifier OP1 serves as an input end of the first comparator 11. For example, a first input end of the first-stage first operational amplifier OP1 is coupled to the first voltage end V1, and a second input end of the first-stage first operational amplifier OP1 is coupled to the output end of the low dropout regulator LDO. A second-stage first operational amplifier OP1 is cascaded to the first-stage first operational amplifier OP1, and a third-stage first operational amplifier OP1 is cascaded to the second-stage first operational amplifier OP1. An output end of the third-stage first operational amplifier OP1 serves as an output end of the first comparator 11.

The plurality of stages of first operational amplifiers OP1 are disposed in the first comparator 11, so that a gain of the first comparator 11 can be greatly increased.

Certainly, the first comparator 11 in embodiments of this application may alternatively include only one stage of first operational amplifier.

In some embodiments, as shown in FIG. 5B, the first comparator 11 further includes a plurality of stages of first inverters (inverter) INV1 coupled to output ends of the plurality of stages of first operational amplifiers OP1. In FIG. 5B, an example in which the first comparator 11 includes two stages of first inverters INV1 is used for illustration.

An input end of a first-stage first inverter INV1 is coupled to an output end of a last-stage first operational amplifier OP1, an input end of a second-stage first inverter INV1 is coupled to the input end of the first-stage first inverter INV1, and an output end of the second-stage first inverter INV1 serves as the output end of the first comparator 11.

The plurality of stages of first inverters INV1 are disposed in the first comparator 11, so that a capability of driving the first switch circuit 13 can be improved, to expand a change range (swing) of the voltage output at the voltage output end VOT, and implement a high-gain and high-speed first comparator 11. The high-gain and high-speed first comparator 11 can improve a processing speed of the first comparator 11, to improve a response speed of the charging module, shorten a recovery time of the second voltage v2 output at the voltage output end VOT, and improve a transient response characteristic of the voltage regulator circuit 10.

Certainly, the first comparator 11 in embodiments of this application may alternatively include only one stage of first inverter INV1.

In some embodiments, the first comparator 11 is, for example, a P-type comparator.

Still refer to FIG. 3. The first delay circuit 12 is configured to: receive the first comparison result Vcp, and output a plurality of first control signals Vc<1:n>.

For example, the first delay circuit 12 includes a first comparison result input end and a plurality of first control signal output ends, and the first comparison result input end of the first delay circuit 12 is coupled to the output end of the first comparator 11. The first control signal output end of the first delay circuit 12 is configured to receive the first comparison result Vcp. The plurality of first control signal output ends of the first delay circuit 12 are correspondingly coupled to the plurality of first switch circuits 13. For example, one first control signal output end of the first delay circuit 12 is coupled to an input end of one first switch circuit 13.

The first delay circuit 12 is configured to: receive the first comparison result through the first comparison result input end, and output the first control signal through the first control signal output end.

In some embodiments, the plurality of first control signal output ends of the first delay circuit 12 are all configured to output a delayed signal obtained by delaying the first comparison result Vcp. Alternatively, it is understood that the first control signals output by the plurality of first control signal output ends of the first delay circuit 12 are all delayed relative to the first comparison result Vcp. In this case, each first switch circuit 13 receives a delayed signal.

In some other embodiments, one of the plurality of first control signal output ends of the first delay circuit 12 is configured to output an undelayed signal (that is, directly output the first comparison result Vcp). The other first control signal output ends are configured to output a delayed signal obtained by delaying the first comparison result Vcp. In this case, one first switch circuit 13 directly receives the first comparison result Vcp, and the other first switch circuits 13 all receive delayed signals. For example, the other first switch circuits 13 sequentially receive the delayed signals, or it is understood that the delayed signals received by the other first switch circuits 13 have different delay degrees, so that the other first switch circuits 13 are turned on sequentially.

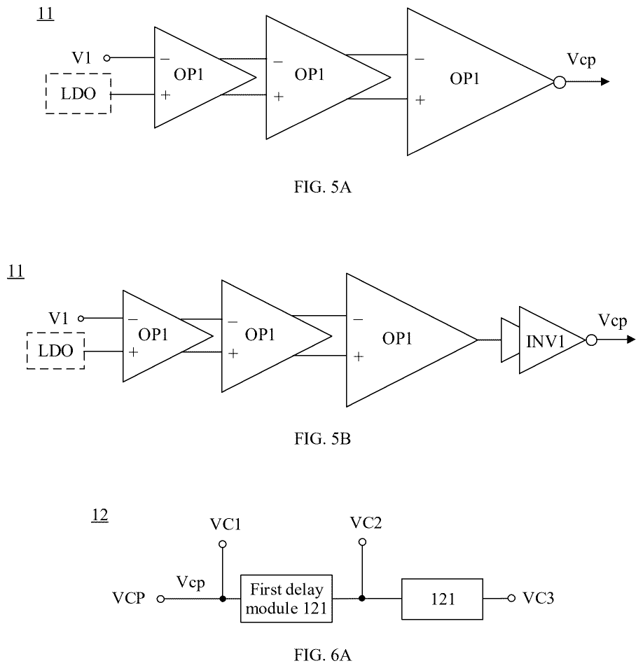

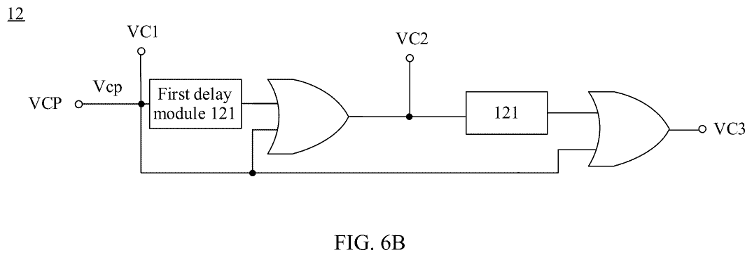

FIG. 6A and FIG. 6B are diagrams of structures of the first delay circuit 12 according to an embodiment of this application.

In some embodiments, as shown in FIG. 6A, the first delay circuit 12 includes a plurality of first delay (delay) modules 121 connected in series, a first comparison result input end VCP, and a plurality of first control signal output ends (for example, VC1, VC2, and VC3).

It may be understood that structures (delay degrees) of the plurality of first delay modules 121 may be the same or different.

In some embodiments, an output end of each first delay module 121 is provided with a first control signal output end. In this way, a first control signal output through each first control signal output end is a delay signal obtained by delaying the first comparison result Vcp.

Certainly, alternatively, output ends of some first delay modules 121 are provided with first control signal output ends, while output ends of some first delay modules 121 are not provided with first control signal output ends.

In some other embodiments, as shown in FIG. 6A, each of an input end and an output end of each first delay module 121 is provided with a first control signal output end.

For example, as shown in FIG. 6A, one first control signal output end is disposed between two adjacent stages of first delay modules 121; and the one first control signal output end between the two adjacent stages of first delay modules 121 serves as a first control signal output end correspondingly configured for an output end of a previous-stage first delay module 121, and also serves as a first control signal output end correspondingly configured for an input end of a next-stage first delay module 121.

Alternatively, for example, two first control signal output ends are disposed between two adjacent stages of first delay modules 121; and one of the two first control signal ends serves as a first control signal output end correspondingly configured for an output end of a previous-stage first delay module 121, and the other one serves as a first control signal output end correspondingly configured for an input end of a next-stage first delay module 121. However, delay degrees of first control signals output by the two first control signal output ends relative to the first comparison result Vcp are the same.

In FIG. 6A, an example in which the first delay circuit 12 includes three first control signal output ends is used for illustration. The three first control signal output ends are a first-stage first control signal output end VC1, a second-stage first control signal output end VC2, and a third-stage first control signal output end VC3.

For example, if a delay degree of each first delay module 121 is 5 nS, a first control signal Vc1 output by the first-stage first control signal output end VC1 is not delayed relative to the first comparison result Vcp, a first control signal Vc2 output by the second-stage first control signal output end VC1 is delayed by 5 nS relative to the first comparison result Vcp, a first control signal Vc3 output by the third-stage first control signal output end VC3 is delayed by 10 nS relative to the first comparison result Vcp, and is delayed by 5 nS relative to the first control signal Vc2.

Certainly, alternatively, input ends and output ends of some first delay modules 121 are provided with first control signal output ends while input ends and/or output ends of some first delay modules 121 are not provided with first control signal output ends.

In embodiments of this application, the first delay circuit 12 includes the plurality of first delay modules 121, the plurality of first delay modules 121 are configured to control the plurality of first switch circuits 13 to be sequentially turned on, and paths on which the plurality of first switch circuits 13 are located obtain currents from the second voltage end V2 at different times, so that voltage fluctuation of the second voltage end V2 can be effectively reduced. In addition, in the application scenario in which the load current changes slightly, turning on the first switch circuits 13 at different stages helps reduce dynamic power consumption.

In some embodiments, as shown in FIG. 6B, the first delay circuit 12 further includes a plurality of OR gates.

The OR gate is configured to: receive signals from the input end and the output end of the first delay module 121, and output a signal obtained through an OR operation to the first control signal output end.

For example, the OR gate is coupled between the first delay module 121 and the first control signal output end. For example, the OR gate includes a first input end, a second input end, and an output end. The first input end of the OR gate is coupled to the input end of the first delay module 121, the second input end of the OR gate is coupled to the output end of the first delay module 121, and the output end of the OR gate is coupled to the first control signal output end.

For example, as shown in FIG. 6B, a first input end of a first-stage OR gate is coupled to an input end (namely, a first-stage first control signal output end VC1) of a first-stage first delay module 121, a second input end of the first-stage OR gate is coupled to an output end of the first-stage first delay module 121, and an output end of the first-stage OR gate is coupled to a second-stage first control signal output end VC2. A first input end of a second-stage OR gate is coupled to an input end (namely, a second-stage first control signal output end VC2) of a second-stage first delay module 121, a second input end of the second-stage OR gate is coupled to an output end of the second-stage first delay module 121, and an output end of the second-stage OR gate is coupled to a third-stage first control signal output end VC3.

For example, when undershoot occurs in the second voltage v2 output by the voltage regulator circuit 10, the first comparison result Vcp output by the first comparator 11 is “0”, and the first comparison result Vcp is still “0” after being delayed by the first delay module 121. After an OR gate operation is performed, output is still “0”. The plurality of first switch circuits 13 are sequentially turned on under control of the first control signals output by the plurality of stages of first control signal output ends. When no undershoot occurs in the second voltage v2 output by the voltage regulator circuit 10, the first comparison result Vcp is “1”. As long as “1” occurs, outputs of the OR gate operation are all “1”. In this case, the plurality of first switch circuits 13 are synchronously turned off.

In embodiments of this application, by disposing the OR gate in the first delay circuit 12, after the second voltage v2 output at the voltage output end VOT is regulated to a normal range, the first comparison result Vcp output by the first comparator 11 is used to control all the first switch circuits 13 to be directly turned off. This can mitigate a case of overcompensation of the second voltage v2 caused by delayed turn-off of a next-stage first switch circuit 13.

Certainly, in FIG. 6B, an example in which an output end of each first delay module 121 is coupled to the OR gate is used for illustration. Alternatively, output ends of some first delay modules 121 may be coupled to OR gates, and output ends of some first delay modules 121 are not coupled to OR gates.

Still refer to FIG. 3. In the plurality of first switch circuits 13 connected in parallel, each first switch circuit 13 is configured to: receive the first control signal Vc, and regulate connection and disconnection between the second voltage end V2 and the voltage output end VOT.

For example, as shown in FIG. 4, the first delay circuit 12 outputs n first control signals Vc<1:n>. A 1^{st} first switch circuit 13 receives a first control signal Vc1 output by the first-stage control signal output end VC1, a second first switch circuit 13 receives a first control signal Vc2 output by the second-stage first control signal output end VC2, a third first switch circuit 13 receives a first control signal Vc3 output by the third-stage first control signal output end VC3, and the like.

As shown in FIG. 4, in some embodiments, the first switch circuit 13 includes a first transistor M1, and the plurality of first switch circuits 13 are a plurality of first transistors M1<1:n>.

A control electrode of each first transistor MI is coupled to the first control signal output end of the first delay circuit 12, a first electrode of the first transistor MI is coupled to the second voltage end V2, and a second electrode of the first transistor MI is coupled to the voltage output end VOT.

For example, the first comparator 11 is a P-type comparator, the corresponding first transistor M1 is a P-type transistor and is turned on under control of a low-level signal, the second voltage end V2 is a supply voltage end VDD, and when undershoot occurs in the second voltage v2, the first switch circuit 13 forms an injection path to perform injection compensation on the second voltage v2, so that the second voltage v2 output at the voltage output end VOT is stabilized within the threshold range.

In embodiments of this application, for a structure of the voltage regulator circuit 10 that uses a digital-analog hybrid architecture, the first comparator 11 is disposed in the voltage regulator circuit 10, to quickly respond to a change of the second voltage v2 output at the voltage output end VOT. In addition, the first delay circuit 12 is configured to control the plurality of first switch circuits 13 to be turned on stage by stage, so that a compensation path between the second voltage end V2 and the voltage output end VOT is established, to compensate for a significant change of the second voltage v2 (an output voltage of the voltage regulator circuit 10) caused by an instantaneous change of a load current, thereby remaining the second voltage v2 within a threshold range. Furthermore, because a value of a current injected to the voltage output end VOT may be adjusted by using the plurality of first switch circuits 13, a value of a current injected to the voltage input end VOT through the second voltage end V2 may be determined based on an actual application scenario, and a load current change range that can be coped with is large. In addition, because a charging path in which the first switch circuit 13 is located draws a large current from the second voltage end V2, and there is a parasitic inductor on a pad bonding (bonding) wire of the second voltage end V2, drawing a current from the second voltage end V2 causes noise fluctuation generated by a supply voltage at the second voltage end V2, to affect normal operation of another module. However, in embodiments of this application, the plurality of first switch circuits 13 are turned on stage by stage, so that a quantity of drawing times is increased based on multi-stage control logic, to reduce the current drawn from the second voltage end V2 each time. A smaller current drawn each time indicates a smaller amplitude of noise fluctuation generated by the supply voltage. Therefore, a problem that the supply voltage fluctuates greatly can be resolved. Moreover, when the plurality of first switch circuits 13 are turned on at different stages, in an application scenario in which the load current changes slightly, the second voltage v2 can be compensated to be within the threshold range when some first switch circuits 13 are turned on. In this case, the remaining first switch circuits 13 do not need to be turned on. This helps reduce dynamic power consumption. Additionally, a circuit structure included in the voltage regulator circuit 10 may be an on-chip integrated structure, so that an area of the voltage regulator circuit 10 can be reduced, and additional costs caused by introducing an off-chip capacitor can be eliminated.

Still refer to FIG. 3. In some embodiments, the voltage regulator circuit 10 further includes a first current source circuit 14, and the first current source circuit 14 is coupled between the second voltage end V2 and the plurality of first switch circuits 13.

The first switch circuit 13 directly draws a current from the second voltage end V2, and the current fluctuates greatly. The first current source circuit 14 is disposed between the second voltage end V2 and the first switch circuit 13, so that the first current source circuit 14 can provide an accurate and fixed charging current value, to improve accuracy of compensating for the second voltage v2, and resolve a problem of a charging/discharging current change value in a wide supply voltage range.

In some embodiments, the first current source circuit 14 includes a current mirror.

The current mirror serves as a current source, so that a charging current value is stable, and the current mirror is applicable to a medium-to-high frequency (hundreds of megahertz level) chip (for example, an MCU chip) with a wide supply voltage range.

For example, a current mirror structure is provided. As shown in FIG. 4, in some embodiments, the first current source circuit 14 includes a second transistor M2, a first current source, and a plurality of third transistors M3<1:n>.

A control electrode of the second transistor M2 is coupled to control electrodes of the plurality of third transistors M3<1:n> and a second electrode of the second transistor M2, a first electrode of the second transistor M2 is coupled to the second voltage end V2, the second electrode of the second transistor M2 is coupled to the first current source, and the first current source is further coupled to a third voltage end V3.

A first electrode of each third transistor M3 is coupled to the second voltage end V2, and a second electrode of each third transistor M3 is coupled to one first switch circuit 13 (for example, a first electrode of the first transistor M1).

In some embodiments, the second voltage end V2 and the third voltage end V3 serve as the supply voltage end VDD and the reference ground voltage end GND for each other.

For example, the second voltage end V2 is the supply voltage end VDD, and the third voltage end V3 is the reference ground voltage end GND.

Currents of a current source branch in which the second transistor M2 and the first current source are located are mirrored to a branch in which the third transistor M3 is located.

Still refer to FIG. 3. In some embodiments, the voltage regulator circuit 10 further includes a first reverse coupling circuit 15. The first reverse coupling circuit 15 is coupled between the first delay circuit 12 and the first current source circuit 14.

For example, as shown in FIG. 4, the first reverse coupling circuit 15 is coupled between the first control signal output end of the first delay circuit 12 and the control electrode of the third transistor M3.

In this embodiment of this application, the first reverse coupling circuit 15 and the third transistor M3 may be in a one-to-one correspondence, or control electrodes of some third transistors M3 may be coupled to the first reverse coupling circuit 15.

The first reverse coupling circuit 15 is disposed, so that a static operating point of the first current source circuit 14 can be stabilized, charging/discharging current fluctuation caused by on/off of the third transistor M3 can be compensated for, and impact of coupling noise on accuracy of the charging current value can be reduced. In this way, the current of the first current source circuit 14 can be more accurately replicated to the voltage output end VOT, and stability of the charging current value is maintained. In addition, noise impact on the supply voltage can be reduced.

In some embodiments, as shown in FIG. 4, the first reverse coupling circuit 15 includes a second inverter INV2 and a first capacitor C1. The second inverter INV2 and the first capacitor C1 are coupled in series between the first control signal output end VC and the control electrode of the third transistor M3.

For example, a first end of the first capacitor C1 is coupled to the control electrode of the third transistor M3, a second end of the first capacitor C1 is coupled to the output end of the inverter INV2, and an input end of the second inverter INV2 is coupled to the first control signal output end VC of the first delay circuit 12.

Certainly, the structure of the first reverse coupling circuit 15 is not limited in embodiments of this application. FIG. 4 is merely an example.

An embodiment of this application further provides a voltage regulator circuit driving method. The method includes the following steps.

A reference voltage Vref is input at a voltage input end VI. A low dropout regulator LDO receives the reference voltage Vref, and outputs a first voltage v1.

A voltage output end VOT is configured to receive the first voltage v1 and output a second voltage v2.

A first threshold voltage Vl is input at a first voltage end V1. A first comparator 11 receives the second voltage v2 and the first threshold voltage Vl, and outputs a first comparison result Vcp.

A first delay circuit 12 receives the first comparison result Vcp, and outputs a plurality of first control signals Vc.

A plurality of first switch circuits 13 separately receive the first control signals Vc, and regulate connection and disconnection between a second voltage end V2 and the voltage output end VOT.

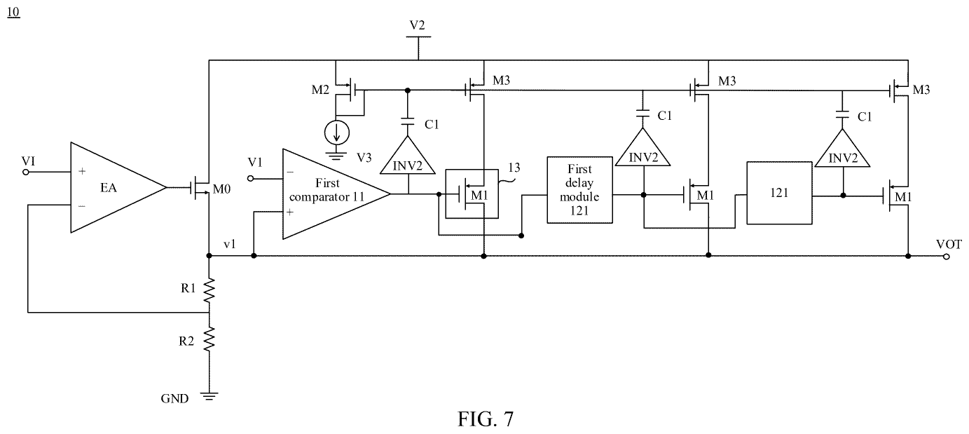

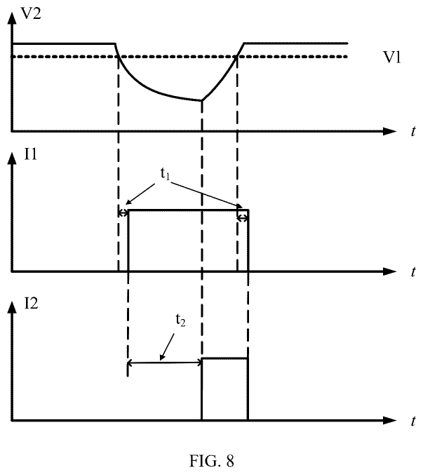

FIG. 7 is a diagram of a detailed structure of the voltage regulator circuit 10 according to an embodiment of this application. FIG. 8 is an effect diagram of transient response of a voltage regulator circuit to undershoot according to an embodiment of this application.

For example, as shown in FIG. 7, an example in which the voltage regulator circuit 10 includes three first switch circuits 13 is used for description. FIG. 8 shows control effect when undershoot occurs in the second voltage v2 output to the voltage output end VOT by the voltage regulator circuit 10 when the load circuit becomes larger.

With reference to FIG. 7 and FIG. 8, when the load current increases, because the voltage regulator circuit 10 does not respond, the second voltage v2 output at the voltage output end VOT changes abruptly accordingly, and an undershoot voltage is generated. When the second voltage v2 is lower than the first threshold voltage Vl (undershoot threshold voltage) input at the first voltage end V1, the first comparator 11 senses that a voltage at a positive input end is lower than a voltage at a negative input end, and after a delay of t1, the first comparator 11 outputs a low-level first comparison result Vcp. The low-level first comparison result Vcp (for example, “0”) is output to the first-stage first transistor M1 through the input end of the first-stage first delay module 121. The low level controls the first-stage first transistor M1 to be turned on. The third transistor M3 coupled to the first transistor M1 injects a first current I1 into the voltage output end VOT, to form a first charging path for compensating for undershoot (increase of the load current) of the second voltage v2. In this way, the undershoot that occurs in the second voltage v2 at the voltage output end VOT is quickly recovered. If a change amplitude of the load current exceeds a maximum current that can be supplied by the third transistor M3, the second-stage first transistor M1 is turned on after a delay t2, and a current I2 continues to be injected into the voltage output end VOT by using the third transistor M3 coupled to the second-stage first transistor M1, to form a second charging path. The second charging path and the first charging path jointly inject a current into the voltage output end VOT.

After the second voltage v2 at the voltage output end VOT is higher than the first threshold voltage Vl, the first comparator 11 senses that a voltage at the positive input end is higher than a voltage at the negative input end, to output a high level (for example, “1”). The high level simultaneously controls the first-stage first transistor M1, the second-stage first transistor M1, and the third-stage first transistor MI to be turned off, the second charging path and the first charging path are simultaneously cut off, and a path on which the third-stage first transistor MI is located is not on and continues to be cut off, to prevent the second voltage v2 at the voltage output end VOT from being excessively increased. In this way, it is ensured that the second voltage v2 is within a range specified by the undershoot threshold.

### Example 2

A main difference between Example 2 and Example 1 lies in that the voltage regulator circuit 10 in Example 1 includes a charging module configured to adjust undershoot, while the voltage regulator circuit 10 in this example includes a discharging module configured to adjust overshoot.

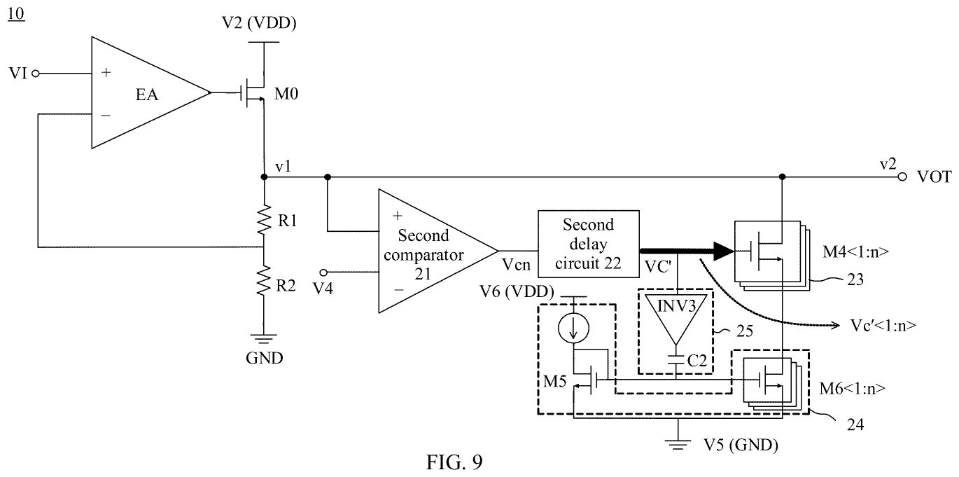

FIG. 9 is a diagram of a topology of a voltage regulator circuit according to an embodiment of this application.

As shown in FIG. 9, the voltage regulator circuit 10 includes a voltage input end VI, a voltage output end VOT, a fourth voltage end V4, and a fifth voltage end V5.

The voltage input VI is, for example, configured to receive a reference voltage Vref, and the reference voltage Vref is, for example, provided by a bandgap (bandgap, BG) reference circuit. The voltage output end VOT is configured to output a stable second voltage v2 to a load. The fourth voltage end V4 is, for example, configured to receive a second threshold voltage, and the second threshold voltage serves as a comparative voltage, to determine whether overshoot (overshoot) occurs in the voltage regulator circuit 10. The fifth voltage end V5 may be, for example, a reference ground voltage end GND, and be configured to receive a reference ground voltage gnd.

The voltage regulator circuit 10 further includes a low dropout regulator LDO and a discharge module. The discharge module includes a second comparator 21, a second delay circuit 22, and a plurality of second switch circuits 23.

The low dropout regulator LDO is configured to: receive the reference voltage Vref at the voltage input end VI, and output a first voltage v1. For example, a structure of the low dropout regulator LDO may be the same as that in Example 1, and details are not described herein again.

Still refer to FIG. 9. The second comparator 21 is configured to: receive the second threshold voltage Vh at the fourth voltage end V4 and the second voltage v2 output at the voltage output end VOT, compare the second threshold voltage Vh with the second voltage v2, and then output a second comparison result Vcn.

Certainly, a value of the second threshold voltage Vh is not limited in embodiments of this application.

A structure of the second comparator 21 may be the same as the structure of the first comparator 11 in Example 1, except that a first input end of the second comparator 21 is configured to receive the second threshold voltage Vh, and the first input end of the first comparator 11 is configured to receive the first threshold voltage Vl.

The second comparator 21 is configured to: detect a change of the second voltage v2, and use the second threshold voltage Vh as a maximum reference voltage within an acceptable range. When the second voltage v2 is greater than the second threshold voltage Vh, it is determined that overshoot occurs in the second voltage v2. The second comparison result Von indicates that overshoot occurs in the second voltage v2. When the second voltage v2 is less than the second threshold voltage Vh, it is determined that no overshoot occurs in the second voltage v2. The second comparison result Von indicates that no overshoot occurs in the second voltage v2.

For example, the second comparator 21 is an n-type comparator. When overshoot occurs in the second voltage v2, the second comparison result Von is “1”. When no overshoot occurs in the second voltage v2, the second comparison result Von is “0”.

Certainly, a type of the second comparator 21 is not limited in embodiments of this application, and a type of the second comparison result Von is not limited either. When overshoot occurs in the second voltage v2, the second comparison result Von output by the second comparator 21 may be used to control the second switch circuit 23 to be turned on. Still refer to FIG. 9. The second delay circuit 22 is configured to receive the second comparison result Vcn, and output a plurality of second control signals Vc′<1:n>.

In some embodiments, a structure of the second delay circuit 22 is the same as the structure of the first delay circuit 12 in Example 1. For details, refer to related descriptions in Example 1.

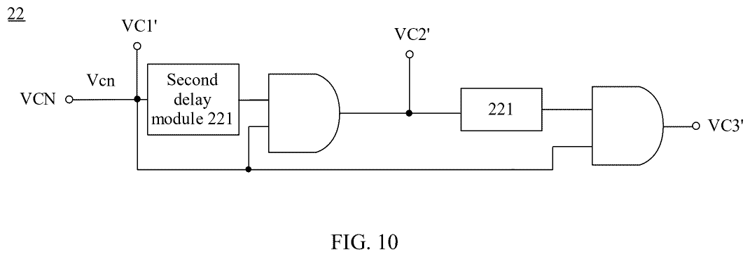

FIG. 10 is a diagram of a structure of the second delay circuit 22 according to an embodiment of this application.

In some other embodiments, as shown in FIG. 10, the second delay circuit 22 includes a plurality of second delay modules 221 connected in series, a plurality of AND gates, a second comparison result input end VCN, and a plurality of second control signal output ends (for example, VC1′, VC2′, and VC3′).

The second delay module 221, the second comparison result input end VCN, and the plurality of second control signal output ends in the second delay circuit 22 may be correspondingly the same as the first delay module 121, the first comparison result input end VCP, and the plurality of first control signal input ends in the first delay circuit 12 shown in FIG. 6B. A main difference lies in that the OR gate in FIG. 6B is replaced with the AND gate in FIG. 10.

The AND gate is configured to: receive signals from an input end and an output end of the second delay module 221, and output a signal obtained through an AND operation to the second control signal output end.

For example, the AND gate is coupled between the second delay module 221 and the second control signal output end. For example, the AND gate includes a first input end, a second input end, and an output end. The first input end of the AND gate is coupled to the input end of the second delay module 221, the second input end of the AND gate is coupled to the output end of the second delay module 221, and the output end of the AND gate is coupled to the second control signal output end.

For example, as shown in FIG. 10, a first input end of a first-stage AND gate is coupled to an input end (namely, a first-stage second control signal output end VC1′) of a first-stage second delay module 221, a second input end of the first-stage AND gate is coupled to an output end of the first-stage second delay module 221, and an output end of the first-stage AND gate is coupled to a second-stage second control signal output end VC2′. A first input end of a second-stage AND gate is coupled to an input end (namely, the second-stage second control signal output end VC2′) of a second-stage second delay module 221, a second input end of the second-stage AND gate is coupled to an output end of the second-stage second delay module 221, and an output end of the second-stage AND gate is coupled to a third-stage second control signal output end VC3′.

For example, when overshoot occurs in the second voltage v2 output at the voltage output end VOT, the second comparison result Von output by the second comparator 21 is “1”, and the second comparison result Von is still “1” after being delayed by the second delay module 221. After an AND gate operation is performed, output is still “1”. The plurality of second switch circuits 23 are sequentially turned on under control of the second control signals output by the plurality of stages of second control signal output ends. When no overshoot occurs in the second voltage v2 output at the voltage output end VOT, the second comparison result Von is “0”. As long as “0” occurs, outputs of the AND gate operation are all “0”. In this case, the plurality of second switch circuits 23 are synchronously turned off.

In embodiments of this application, by disposing the AND gate in the second delay circuit 22, after the second voltage v2 output at the voltage output end VOT is regulated to a normal range, the second comparison result Ven output by the second comparator 21 is used to control all the second switch circuits 23 to be directly turned off. This can mitigate a case of overcompensation of the second voltage v2 caused by delayed turn-off of a next-stage second switch circuit 23.

Certainly, in FIG. 10, an example in which an output end of each second delay module 221 is coupled to the AND gate is used for illustration. Alternatively, output ends of some second delay modules 221 may be coupled to AND gates, and output ends of some second delay modules 221 are not coupled to AND gates.

Still refer to FIG. 9. In the plurality of second switch circuits 23 connected in parallel, each second switch circuit 23 is configured to: receive the second control signal Vc′, and regulate connection and disconnection between the fifth voltage end V5 and the voltage output end VOT.

A disposing position and a principle of the second switch circuit 23 in this example are the same as those of the first switch circuit 13 in Example 1. For details, refer to related descriptions in Example 1.

In some embodiments, the second switch circuit 23 includes a fourth transistor M4, and the plurality of second switch circuits 23 are a plurality of fourth transistors M4<1:n>.

A correspondence between the plurality of fourth transistors M4<1:n> and the second delay circuit 22 may be the same as a correspondence between the plurality of first transistors M1<1:n> and the first delay circuit 12.

For example, the second comparator 21 is an N-type comparator, the corresponding fourth transistor M4 is an N-type transistor and is turned on under control of a high-level signal, the fifth voltage end V5 is a reference ground voltage end GND, and when overshoot occurs in the second voltage v2, the second switch circuit 23 forms a discharge path to perform discharge compensation on the second voltage v2, so that the second voltage v2 output at the voltage output end VOT is stabilized within the threshold range.

The solution in this example may be understood as follows: The first transistor M1 in Example 1 is changed from the P-type transistor to the N-type transistor, and the second voltage end V2 is changed from the supply voltage end VDD to the reference ground voltage end GND.

The voltage regulator circuit 10 in Example 1 may compensate for undershoot of the output voltage. In this example, the voltage regulator circuit 10 may compensate for overshoot of the output voltage. Other effect is the same as that in Example 1, and details are not described herein again.

Still refer to FIG. 9. In some embodiments, the voltage regulator circuit 10 further includes a second current source circuit 24, and the second current source circuit 24 is coupled between the fifth voltage end V5 and the plurality of second switch circuits 23.

A structure and a principle of the second current source circuit 24 may be the same as a structure and a principle of the first current source circuit 14 in Example 1, and details are not described herein again.

For example, as shown in FIG. 9, the second current source circuit 24 includes a fifth transistor M5, a second current source, and a plurality of sixth transistors M6<1:n>.

A control electrode of the fifth transistor M5 is coupled to control electrodes of the plurality of sixth transistors M6<1:n> and a second electrode of the fifth transistor M5, a first electrode of the fifth transistor M5 is coupled to the second voltage end V2, the second electrode of the fifth transistor M5 is coupled to the second current source, and the second current source is further coupled to a sixth voltage end V6.

A first electrode of each sixth transistor M6 is coupled to the fifth voltage end V5, and a second electrode of each sixth transistor M6 is coupled to one second switch circuit 23 (for example, a first electrode of the fourth transistor M4).

In some embodiments, the fifth voltage end V5 and the sixth voltage end V6 serve as the supply voltage end VDD and the reference ground voltage end GND for each other.

For example, the sixth voltage end V6 is the supply voltage end VDD, and the fifth voltage end V5 is the reference ground voltage end GND.

Still refer to FIG. 9. In some embodiments, the voltage regulator circuit 10 further includes a second reverse coupling circuit 25. The second reverse coupling circuit 25 is coupled between the second delay circuit 22 and the second current source circuit 24.

A structure and a principle of the second reverse coupling circuit 25 may be the same as a structure and a principle of the first reverse coupling circuit 15 in Example 1, and details are not described herein again.

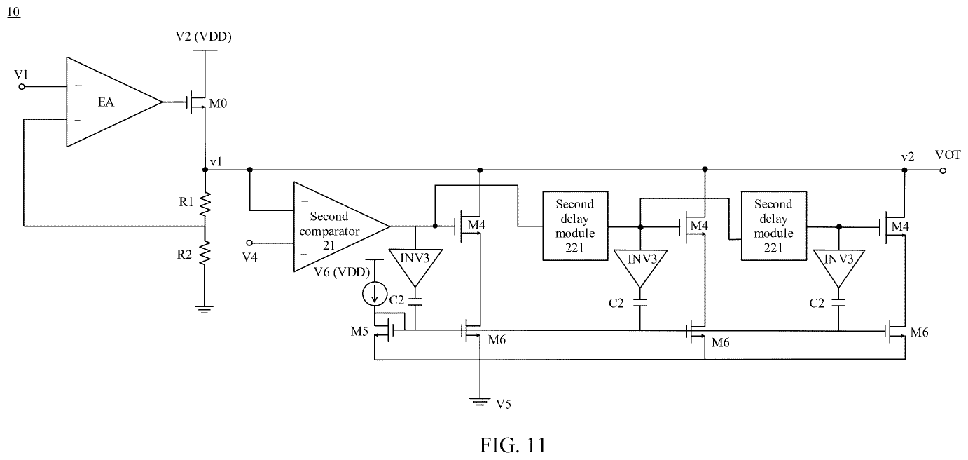

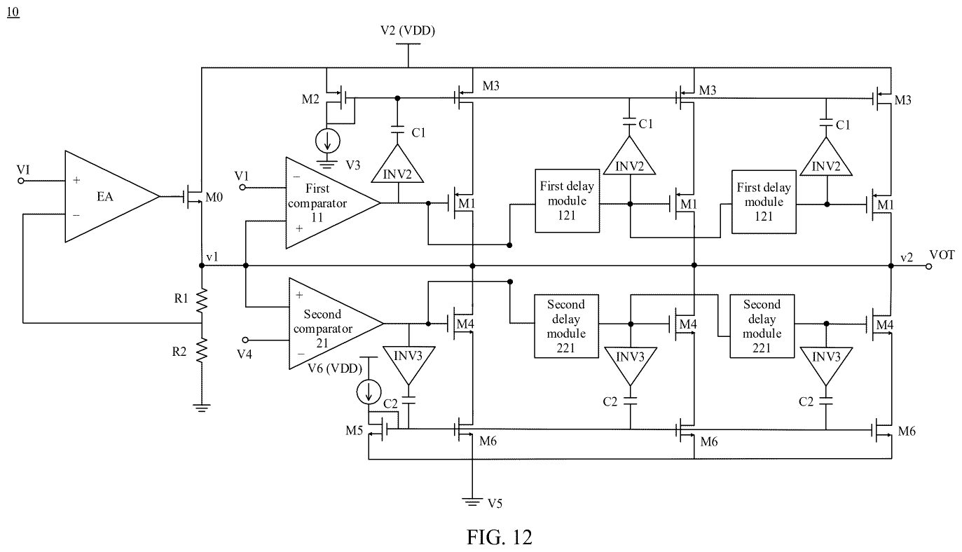

FIG. 11 is a diagram of a structure of the voltage regulator circuit 10 according to an embodiment of this application.

When the load current decreases, because the voltage regulator circuit 10 does not respond, the second voltage v2 output at the voltage output end VOT changes abruptly accordingly, and an overshoot voltage is generated.

When the second voltage v2 is higher than the second threshold voltage Vh (overshoot threshold voltage) input at the fourth voltage end V4, the second comparator 21 senses that a voltage at a positive input end is higher than a voltage at a negative input end, and the second comparator 21 outputs a high-level second comparison result Vcn. The high-level second comparison result Von (for example, “1”) is output to the first-stage fourth transistor M4 through the input end of the first-stage second delay module 221. The high level controls the first-stage fourth transistor M4 to be turned on. The sixth transistor M6 coupled to the fourth transistor M4 provides a current path to the ground for the voltage output end VOT, to form a first discharge path. An excess current of the voltage output end VOT may be discharged through the first discharge path, to compensate for overshoot (decrease of the load current) of the second voltage v2. In this way, the overshoot that occurs in the second voltage v2 at the voltage output end VOT is quickly recovered. If a change amplitude of the load current exceeds a maximum current that can be supplied by the sixth transistor M6, the second-stage fourth transistor M4 is turned on after a delay, and the sixth transistor M6 coupled to the second-stage fourth transistor M4 continues to provide a current path to the ground for the voltage output end VOT, to form a second discharge path. The first discharge path and the second discharge path jointly discharge a current for the voltage output end VOT.

After the second voltage v2 at the voltage output end VOT is lower than the second threshold voltage Vh, the second comparator 21 senses that a voltage at the positive input end is lower than a voltage at the negative input end, to output a low level (for example, “0”). The low level simultaneously controls the first-stage fourth transistor M4, the second-stage fourth transistor M4, and the third-stage fourth transistor M4 to be turned off, the second discharge path and the first discharge path are simultaneously cut off, and a path on which the third-stage fourth transistor M4 is located is not on and continues to be cut off, to prevent the second voltage v2 at the voltage output end VOT from being excessively reduced. In this way, it is ensured that the second voltage v2 is within a range specified by the overshoot threshold.

In some embodiments, in Example 1, the second voltage end V2 is the reference ground voltage end GND (equivalent to the fifth voltage end V5 in this example), the third voltage end V3 is the supply voltage end VDD (equivalent to the sixth voltage end V6 in this example), and when the first transistor M1, the second transistor M2, and the third transistor M3 are N-type transistors, and the first comparator 11 is an N-type comparator, the voltage regulator circuit 10 may also compensate for overshoot.

### Example 3

The voltage regulator circuit 10 provided in Example 3 includes both the charging module configured to adjust the undershoot in Example 1 and the discharging module configured to adjust the overshoot.

FIG. 12 is a diagram of a topology of a voltage regulator circuit according to an embodiment of this application.

As shown in FIG. 12, the voltage regulator circuit 10 includes both the charging module in Example 1 and the discharging module in Example 2, so that the second voltage v2 output at the voltage regulator circuit 10 falls within a range specified by the overshoot threshold and the undershoot threshold.

The voltage regulator circuit 10 provided in this embodiment of this application may be integrated into a same chip. The voltage regulator circuit 10 is disposed on a substrate (for example, a silicon substrate), and serves as a low dropout regulator chip provided in embodiments of this application. The low dropout regulator chip provided in embodiments of this application may be a bare chip, or may be a packaged chip.

Embodiments of this application further provide a chip system. The chip system includes a load circuit and the voltage regulator circuit 10 provided in embodiments of this application. The voltage output end VOT of the voltage regulator circuit 10 is coupled to the load circuit. Alternatively, the chip system includes a load circuit and the low dropout regulator chip provided in embodiments of this application. The voltage output end VOT in the low dropout regulator chip is coupled to the load circuit.

The chip system may be, for example, a microcontroller unit (MCU), a radio frequency (RF) transceiver, or a high-speed digital circuit (for example, a chip system SoC).

Embodiments of this application further provide an electronic device. The electronic device includes any one of the voltage regulator circuit 10, the low dropout regulator chip, or the chip system provided above. The voltage regulator circuit 10 is configured to supply power to a load circuit, and the voltage regulator circuit 10 may be disposed on a circuit board in the electronic device.

It should be noted that all the related descriptions of the voltage regulator circuit 10 provided above may be referred to the chip system and the electronic device. Details are not described in embodiments of this application.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A voltage regulator circuit, comprising:
a voltage input end, a voltage output end, a first voltage end, and a second voltage end;
a low dropout regulator, the low dropout regulator configured to:
receive a reference voltage at the voltage input end; and
output a first voltage;
wherein the voltage output end is configured to:
receive the first voltage; and
output a second voltage;
a first comparator, the first comparator configured to:
receive a first threshold voltage at the first voltage end and the second voltage; and
output a first comparison result;
a first delay circuit, the first delay circuit configured to:
receive the first comparison result; and
output a plurality of first control signals; and
a plurality of first switch circuits connected in parallel, wherein each first switch circuit is configured to:
receive the first control signal; and
regulate connection and disconnection between the second voltage end and the voltage output end.

2. The voltage regulator circuit according to claim 1, wherein:
the voltage regulator circuit further comprises a first current source circuit; and
the first current source circuit is coupled between the second voltage end and the plurality of first switch circuits.

3. The voltage regulator circuit according to claim 2, wherein:
the voltage regulator circuit further comprises a first reverse coupling circuit; and
the first reverse coupling circuit is coupled between the first delay circuit and the first current source circuit.

4. The voltage regulator circuit according to claim 1, wherein:
the first delay circuit comprises a plurality of first delay modules connected in series, a first comparison result input end, and a plurality of first control signal output ends, and each of an input end and an output end of each first delay module is provided with a first control signal output end; and
the first delay circuit is configured to:
receive the first comparison result through the first comparison result input end; and
output the first control signal through the first control signal output end.

5. The voltage regulator circuit according to claim 4, wherein at least one of:
the first delay circuit further comprises a plurality of OR gates, and each OR gate is configured to:
receive signals from the input end and the output end of the first delay module; and
output a signal obtained through an OR operation to the first control signal output end; or
the first delay circuit further comprises a plurality of AND gates, and each AND gate is configured to:
receive signals from the input end and the output end of the first delay module; and
output a signal obtained through an AND operation to the first control signal output end.

6. The voltage regulator circuit according to claim 1, wherein the first comparator comprises a plurality of stages of cascaded first operational amplifiers.

7. The voltage regulator circuit according to claim 6, wherein the first comparator further comprises a plurality of stages of first inverters coupled to output ends of the plurality of stages of first operational amplifiers.

8. The voltage regulator circuit according to claim 1, wherein:
the first switch circuit comprises a first transistor; and
a control electrode of the first transistor is coupled to the first delay circuit, a first electrode of the first transistor is coupled to the second voltage end, and a second electrode of the first transistor is coupled to the voltage output end.

9. The voltage regulator circuit according to claim 8, wherein:
the first transistor is a P-type transistor, and the second voltage end is a supply voltage end; or
the first transistor is an N-type transistor, and the second voltage end is a reference ground voltage end.

10. The voltage regulator circuit according to claim 2, wherein the first current source circuit comprises a current mirror.

11. The voltage regulator circuit according to claim 2, wherein:
the first current source circuit comprises a second transistor, a first current source, and a plurality of third transistors;
a control electrode of the second transistor is coupled to control electrodes of the plurality of third transistors and a second electrode of the second transistor, a first electrode of the second transistor is coupled to the second voltage end, and the second electrode of the second transistor is coupled to the first current source;
the first current source is further coupled to a third voltage end; and
a first electrode of each third transistor is coupled to the second voltage end, and a second electrode of each third transistor is coupled to one of the first switch circuits.

12. The voltage regulator circuit according to claim 11, wherein the second voltage end and the third voltage end serve as a supply voltage end and a reference ground voltage end for each other.

13. The voltage regulator circuit according to claim 11, wherein:
the first reverse coupling circuit comprises a second inverter and a first capacitor; and
the second inverter and the first capacitor are coupled in series between the first control signal output end and the control electrode of the third transistor.

14. The voltage regulator circuit according to claim 1, wherein:
the voltage regulator circuit further comprises a second comparator, a second delay circuit, a plurality of second switch circuits connected in parallel, a fourth voltage end, and a fifth voltage end;
the second comparator is configured to:
receive a second threshold voltage at the fourth voltage end and the second voltage; and
output a second comparison result;
the second delay circuit is configured to:
receive the second comparison result; and
output a plurality of second control signals; and
each second switch circuit is configured to:
receive the second control signal; and
regulate connection and disconnection between the fifth voltage end and the voltage output end.

15. The voltage regulator circuit according to claim 14, wherein:
the voltage regulator circuit further comprises a second current source circuit; and
the second current source circuit is coupled between the fifth voltage end and the plurality of second switch circuits.

16. The voltage regulator circuit according to claim 15, wherein:
the voltage regulator circuit further comprises a second reverse coupling circuit; and
the second reverse coupling circuit is coupled between the second delay circuit and the second current source circuit.

17. A low dropout regulator chip, comprising a substrate and a voltage regulator circuit, wherein the voltage regulator circuit, comprises:
a voltage input end, a voltage output end, a first voltage end, and a second voltage end;
a low dropout regulator, the low dropout regulator configured to:
receive a reference voltage at the voltage input end; and
output a first voltage, wherein
the voltage output end is configured to:
receive the first voltage; and
output a second voltage;
a first comparator, the first comparator configured to:
receive a first threshold voltage at the first voltage end and the second voltage; and
output a first comparison result;
a first delay circuit, the first delay circuit configured to:
receive the first comparison result; and
output a plurality of first control signals; and
a plurality of first switch circuits connected in parallel, wherein each first switch circuit is configured to:
receive the first control signal; and
regulate connection and disconnection between the second voltage end and the voltage output end; and
wherein the voltage regulator circuit is disposed on the substrate.

18. A chip system, comprising a voltage regulator circuit, wherein the voltage regulator circuit, comprises:
a voltage input end, a voltage output end, a first voltage end, and a second voltage end;
a low dropout regulator, the low dropout regulator configured to:
receive a reference voltage at the voltage input end; and
output a first voltage;
wherein the voltage output end is configured to:
receive the first voltage; and
output a second voltage;
a first comparator, the first comparator configured to:
receive a first threshold voltage at the first voltage end and the second voltage; and
output a first comparison result;
a first delay circuit, the first delay circuit configured to:
receive the first comparison result; and
output a plurality of first control signals; and
a plurality of first switch circuits connected in parallel, wherein each first switch circuit is configured to:
receive the first control signal; and
regulate connection and disconnection between the second voltage end and the voltage output end; and
wherein the voltage output end of the voltage regulator circuit is coupled to a load circuit.

19. An electronic device, comprising a voltage regulator circuit, wherein the voltage regulator circuit, comprises:
a voltage input end, a voltage output end, a first voltage end, and a second voltage end;
a low dropout regulator, configured to:
receive a reference voltage at the voltage input end; and
output a first voltage, wherein
the voltage output end is configured to:
receive the first voltage; and
output a second voltage;
a first comparator, configured to:
receive a first threshold voltage at the first voltage end and the second voltage; and
output a first comparison result;
a first delay circuit, configured to:
receive the first comparison result; and
output a plurality of first control signals; and
a plurality of first switch circuits connected in parallel, wherein each first switch circuit is configured to:
receive the first control signal; and
regulate connection and disconnection between the second voltage end and the voltage output end; and
wherein the voltage regulator circuit is disposed on a circuit board.

20. The electronic device according to claim 19, wherein:
the voltage regulator circuit further comprises a first current source circuit; and
the first current source circuit is coupled between the second voltage end and the plurality of first switch circuits.
